(19) United States
(12) Patent Application Publication
(10) Pub. No.: US 2004/0223184 A1
(43) Pub. Date: Nov. 11, 2004

(54) Wireless communication device, method and program

(75) Inventors: Akiko Kusumoto, Kawasaki (JP); Kazuhiro Ichiyanagi, Kawasaki (JP); Yuji Nagano, Yokohama (JP); Shinichirou Miyajima, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/849,183

(22) Filed: May 20, 2004

(30) Foreign Application Priority Data
May 11, 2003 (JP) 2003-375871

(51) Int. Cl. G06F 15/00; H04N 1/327

(52) U.S. Cl. 358/1.15; 709/206

(57) ABSTRACT

A wireless communication device whereby data quality matching the wireless communication state can be determined at the transmitting side alone. Wireless communication state judging unit judges the state of wireless communication with a master station, whereupon image quality decision unit determines quality of image to be encoded by an image encoding unit, in accordance with the wireless communication state, and image quality instruction unit instructs the image encoding unit to encode image with the quality determined by the image quality decision unit. Image acquired by a camera is encoded by the image encoding unit to obtain image data of the instructed quality, and the image encoded by the image encoding unit is transmitted by wireless communication unit to the master station by wireless.

### BACKGROUND OF THE INVENTION

(1) Field of the Invention

The present invention relates to wireless communication device, method and program used for transmitting image etc. from a mobile unit, and more particularly, to wireless communication device, method and program for transmitting such data by wireless.

(2) Description of the Related Art

When a data packet is transmitted over a conventional wireless LAN (Local Area Network) system, success or failure of the transmission of the data packet is judged by determining whether or not ACK (affirmative response) has been returned in response to the transmitted packet. If no ACK is returned, it is judged that the transmission failed, and the data packet is retransmitted.

This transmission procedure is, however, not effective in transmitting data that admits of no delay, such as motion pictures. Accordingly, there has been proposed a communication system wherein an image encoding unit is instructed to increase/decrease the amount of transmit data in accordance with the data error rate measured at the receiving side (see e.g. Japanese Unexamined Patent Publication No. 11-308297 (FIG. 1)). With this communication system, reliable data transmission is available.

It is, however, difficult to apply the technique disclosed in Japanese Unexamined Patent Publication No. 11-308297 to wireless LAN systems in which the access point for communicating with a wireless communication device is switched as need arises.

Specifically, the technique described in Unexamined Japanese Patent Publication No. H11-308297 requires the function of measuring the data error rate at the receiving side and obtaining the amount of data to be transmitted next time. However, in cases where each access point of a wireless LAN is imparted the same function, each time the access point is switched to another because of movement of the wireless communication device, the data error rate must be measured at the then-connected access point. Moreover, where a large number of wireless communication devices are connected to one access point, the access point must calculate the data error rates for all communication devices.

Generally, the access point is required to ensure stable communication states. Thus, if excessive processing load is imposed on the access point and communications via the access point become unstable as a result, the primary function of the access point is impaired. It is therefore impractical to cause each access point to measure the error rates of data transmitted from numerous wireless communication devices.

Also, in ordinary wireless LAN systems, there are occasions when data (image packets) cannot be transmitted because of the processing load imposed on the wireless communication device such as by authentication or transmission of control frames. If packets are transmitted on such occasions in disregard of the processing load, image frame drop or image data error occurs due to shortage of processing time. As a result, motion picture is interrupted at the receiving side, hindering real-time monitoring etc.

### SUMMARY OF THE INVENTION

The present invention was created in view of the above circumstances, and an object thereof is to provide wireless communication device, method and program whereby data quality matching the wireless communication state can be determined at the transmitting side alone.

To achieve the object, there is provided a wireless communication device for performing wireless communication with a master station. The wireless communication device comprises an image encoding unit for encoding image acquired by a camera to obtain image data of instructed quality, wireless communication means for transmitting, by wireless, the image encoded by the image encoding unit to the master station, wireless communication state judging means for judging a state of the wireless communication with the master station, image quality decision means for determining quality of image to be encoded by the image encoding unit, in accordance with the wireless communication state, and image quality instruction means for instructing the image encoding unit to encode the image with the quality determined by the image quality decision means.

Also, to achieve the above object, there is provided a wireless communication program for performing wireless communication with a master station. The wireless communication program causes a computer to function as wireless communication means for transmitting image encoded by an image encoding unit which encodes image acquired by a camera to obtain image data of instructed quality, to the master station by wireless, wireless communication state judging means for judging a state of the wireless communication with the master station, image quality decision means for determining quality of image to be encoded by the image encoding unit, in accordance with the wireless communication state, and image quality instruction means for instructing the image encoding unit to encode the image with the quality determined by the image quality decision means.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram of the invention applied to embodiments;

FIG. 2 is a diagram illustrating an exemplary application of a system according to a first embodiment;

FIG. 3 is a diagram illustrating an exemplary configuration of a communication system according to the first embodiment;

FIG. 4 is a diagram illustrating an exemplary hardware configuration of a wireless communication device used in the embodiments of the present invention;

FIG. 5 is a block diagram illustrating a functional configuration of the wireless communication device;

FIG. 6 is a diagram illustrating an exemplary data structure of a processing load amount-bit rate correspondence table;

FIG. 7 is a diagram illustrating an exemplary data structure of a receive level-bit rate correspondence table;

FIG. 8 is a diagram illustrating an exemplary data structure of an instruction set value table;

FIG. 9 is a flowchart illustrating an optimum encoding bit rate decision procedure;

FIG. 10 is a diagram illustrating the relationship between processing load amount and optimum encoding bit rate;

FIG. 11 is a diagram illustrating the relationship between receive level and optimum encoding bit rate;

FIG. 12 is a diagram showing optimum encoding bit rates matching respective combinations of processing load amount and receive level;

FIG. 13 is a diagram illustrating flows of image data transmitted from an image encoding unit;

FIG. 14 is a block diagram illustrating an internal configuration of a wireless communication device according to a second embodiment;

FIG. 15 is a diagram illustrating an exemplary data structure of a receive level transition table;

FIG. 16 is a flowchart illustrating an optimum encoding bit rate decision procedure according to the second embodiment;

FIG. 17 is a diagram illustrating an example of how the receive level is predicted;

FIG. 18 is a diagram illustrating the relationship between predicted receive level and optimum encoding bit rate corresponding thereto;

FIG. 19 is a block diagram illustrating a functional configuration of a wireless communication device according to a third embodiment; and

FIG. 20 is a flowchart illustrating an optimum encoding bit rate decision procedure according to the third embodiment.

### DESCRIPTION OF THE PREFERRED EMBODIMENTS

Embodiments of the present invention will be hereinafter described with reference to the drawings.

First, the invention applied to the embodiments will be outlined, and then specific embodiments will be explained.

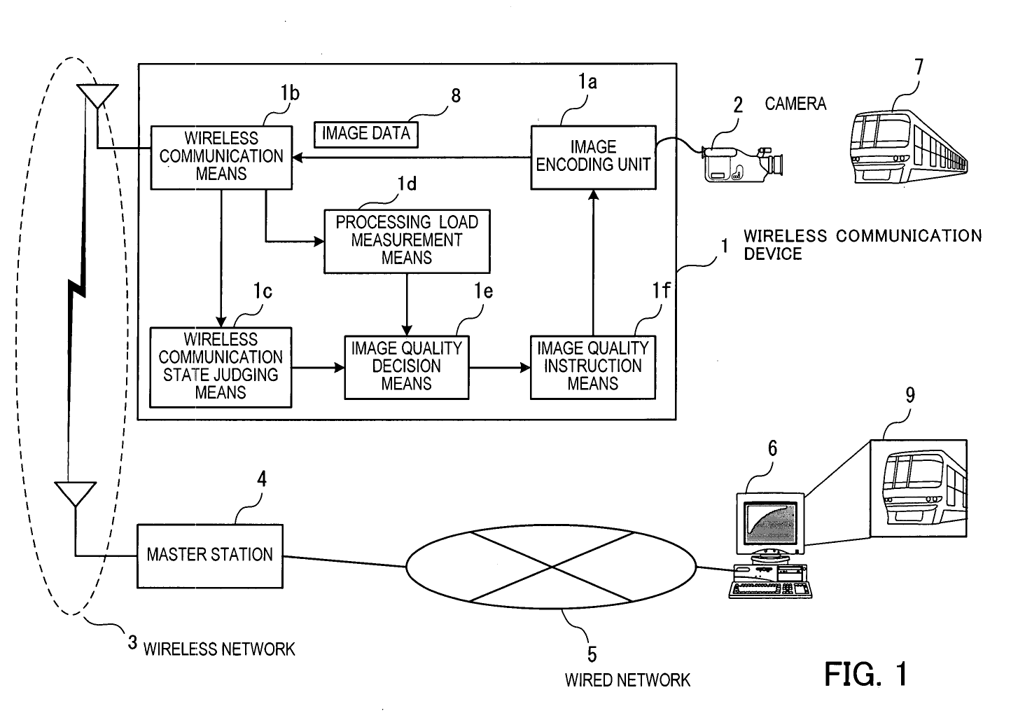

FIG. 1 is a conceptual diagram of the invention applied to the embodiments. A wireless communication device 1 of the present invention is capable of transmitting image data 8 of an object 7 (e.g., data of streaming packets), acquired by a camera 2, to a master station 4 through a wireless network 3. The transmitted image data 8 can be reproduced by a reproducing device 6 so that an image 9 can be displayed. To this end, the wireless communication device 1 comprises an image encoding unit 1a, wireless communication means 1b, wireless communication state judging means 1c, processing load measurement means 1d, image quality decision means 1e, and image quality instruction means 1f.

The image encoding unit 1a encodes image acquired by the camera 2 to obtain image data 8 of instructed quality. For example, the image is encoded according to MPEG (Moving Picture Experts Group)-2 format. In this case, the higher the encoded image quality, the larger amount the image data 8 has.

The wireless communication means 1b transmits, by wireless, the image data 8 encoded by the image encoding unit 1a to the master station 4. The image data 8 thus transmitted by wireless is received by the master station 4 and then received by the reproducing device 6 via a wired network 5.

The wireless communication state judging means 1c judges the state of wireless communication with the master station 4. The communication state can be judged on the basis of the receive level of a beacon signal transmitted from the master station 4, for example. Alternatively, the communication state may be judged on the basis of CRC (Cyclic Redundancy Check) error of the received beacon signal.

The processing load measurement means 1d measures the amount of processing load on the wireless communication means 1b. Where the wireless communication means 1b includes a processor, for example, the amount of processing load can be measured based on the length of idle time of the processor.

The image quality decision means 1e determines the quality of image to be encoded by the image encoding unit 1a, in accordance with the wireless communication state and the amount of processing load on the wireless communication means 1b. For example, the image quality decision means 1e determines an image quality matching the wireless communication state as well as an image quality matching the amount of processing load on the wireless communication means 1b. Then, the image quality decision means 1e determines a lower image quality (smaller data amount) of the determined image qualities as the quality of image to be encoded by the image encoding unit 1a.

The image quality instruction means 1f instructs the image encoding unit 1a to encode image with the quality determined by the image quality decision means 1e.

With the aforementioned wireless communication device 1, the wireless communication state judging means 1c judges the state of wireless communication with the master station 4. Thereupon, in accordance with the wireless communication state, the image quality decision means 1e determines the quality of image to be encoded by the image encoding unit 1a. Further, the image quality instruction means 1f instructs the image encoding unit 1a to encode image with the quality determined by the image quality decision means 1e. Thus, the image encoding unit 1a encodes image acquired by the camera 2 to obtain image data of the instructed quality. The image encoded by the image encoding unit 1a is transmitted by wireless from the wireless communication means 1b to the master station 4. The image data 8 transmitted to the master station 4 is then delivered to the reproducing device 6 through the wired network 5 and the image 9 is reproduced by the device 6.

Thus, according to the present invention, the wireless communication device 1 supplies the image encoding unit 1a with control instructions according to the wireless communication state and the load state so that the quality (data amount) of the image data 8 may be dynamically controlled. This makes it possible to avoid a useless procedure of error-and-retransmission and to carry out efficient and stable transmission.

Moreover, since the wireless communication device 1 itself determines the quality of image to be transmitted therefrom, the transmission of image data can be continued even in the case where the master station is switched to another.

[First Embodiment]

Embodiments of the present invention will be now described in detail. The use of a system to which the present invention is applied permits real-time and stable delivery of image captured on a moving vehicle etc. For example, image showing the rising of a river, captured by a camera on a day of heavy rainfall while traveling along the river, can be transmitted in real time to a river management center.

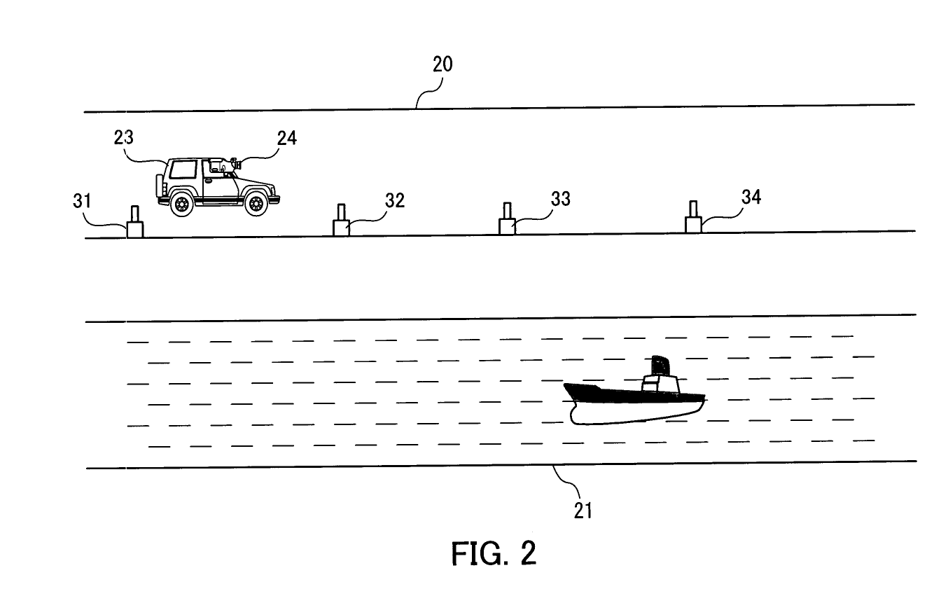

FIG. 2 illustrates an exemplary application of a system according to a first embodiment. As shown in FIG. 2, access points 31, 32, 33, 34, . . . are installed at predetermined intervals along a road 20 that runs along a river 21. The access points 31, 32, 33, 34, . . . each function as a master station of a wireless network.

A manager of the river 21 captures image of the river 2i with a camera 24 while traveling on a motor vehicle 23 along the road 20. The camera 24 is connected to a wireless communication device of this embodiment and the captured image can be delivered via the access points 31, 32, 33, 34, . . . .

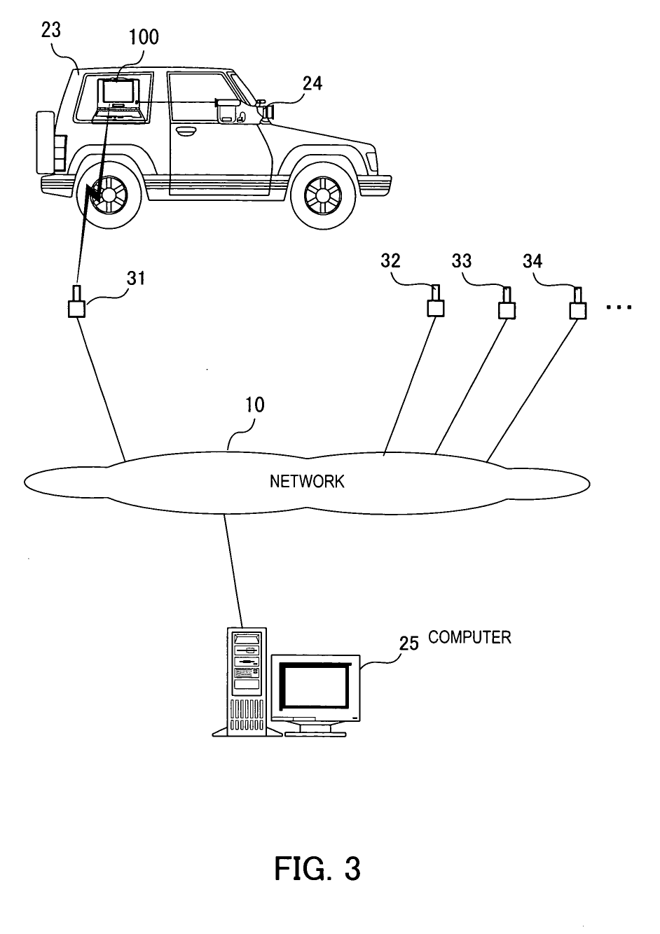

FIG. 3 illustrates an exemplary configuration of a communication system according to the first embodiment. The camera 24 is connected to a wireless communication device 100 mounted on the vehicle 23. The wireless communication device 100 functions as a sub-station of the wireless network.

The access points 31, 32, 33, 34, . . . , each of which serves as a master station, are connected to a wired network 10. To the network 10 is connected a computer 25 which functions as a device for reproducing image data.

The wireless communication device 100 communicates with any of the access points by wireless, to thereby communicate with the computer 25 through the network 10. For example, motion picture image data is delivered from the wireless communication device 100 to the computer 25. Also, a voice call can be established according to VoIP (Voice over IP) between the wireless communication device 100 and the computer 25.

With this system configuration, image of the river 21 is captured by the camera 24, whereupon the motion picture showing the conditions of the river 21 is delivered in real time to the computer 25 via the wireless communication device 100.

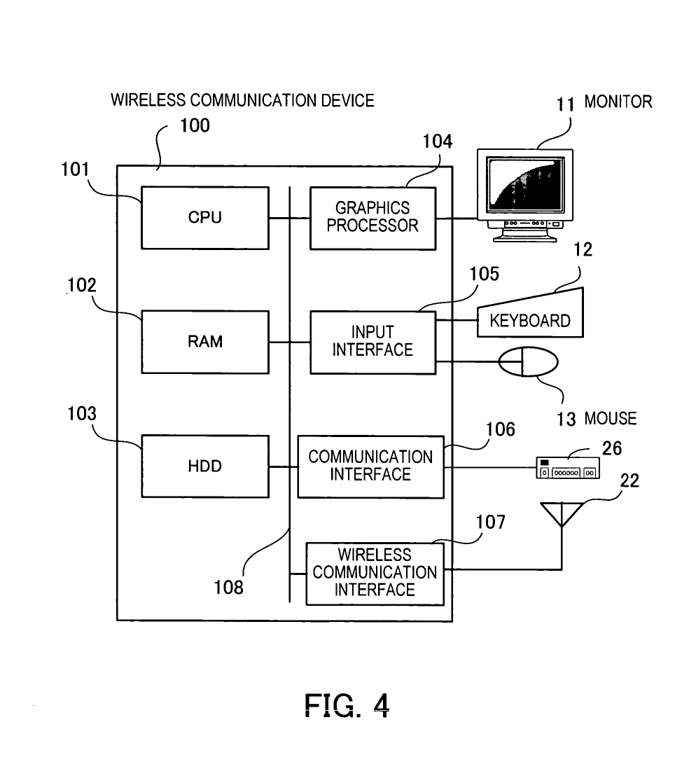

FIG. 4 illustrates an exemplary hardware configuration of the wireless communication device used in the embodiments of the present invention. The wireless communication device 100 is in its entirety under the control of a CPU (Central Processing Unit) 101. To the CPU 101 are connected, via a bus 108, a RAM (Random Access Memory) 102, a hard disk drive (HDD) 103, a graphics processor 104, an input interface 105, a communication interface 106, and a wireless communication interface 107.

The RAM 102 temporarily stores at least part of OS (Operating System) programs and application programs executed by the CPU 101. Also, the RAM 102 stores various other data necessary for the processing by the CPU 101. The HDD 103 stores the OS and application programs.

The graphics processor 104 is connected with a monitor 11. In accordance with instructions from the CPU 101, the graphics processor 104 causes the monitor 11 to display image on a screen thereof. The input interface 105 is connected with a keyboard 12 and a mouse 13, and supplies signals from the keyboard 12 and the mouse 13 to the CPU 101 via the bus 108.

The communication interface 106 is connected to a switching hub 26 and transmits/receives data to/from devices such as the camera 24 through the switching hub 26.

The wireless communication interface 107 is connected to an antenna 22 and transmits/receives data by wireless to/from any one of the access points through the antenna 22.

With the hardware configuration described above, processing functions of this embodiment are accomplished. Although FIG. 4 exemplifies the hardware configuration of the wireless communication device 100, the computer 25 may also have an identical hardware configuration. In this case, however, the wireless communication interface may be omitted from the computer 25.

In the first embodiment, the CPU 101 controls the wireless communication device 100 in accordance with a predetermined program, whereby functions described below are performed.

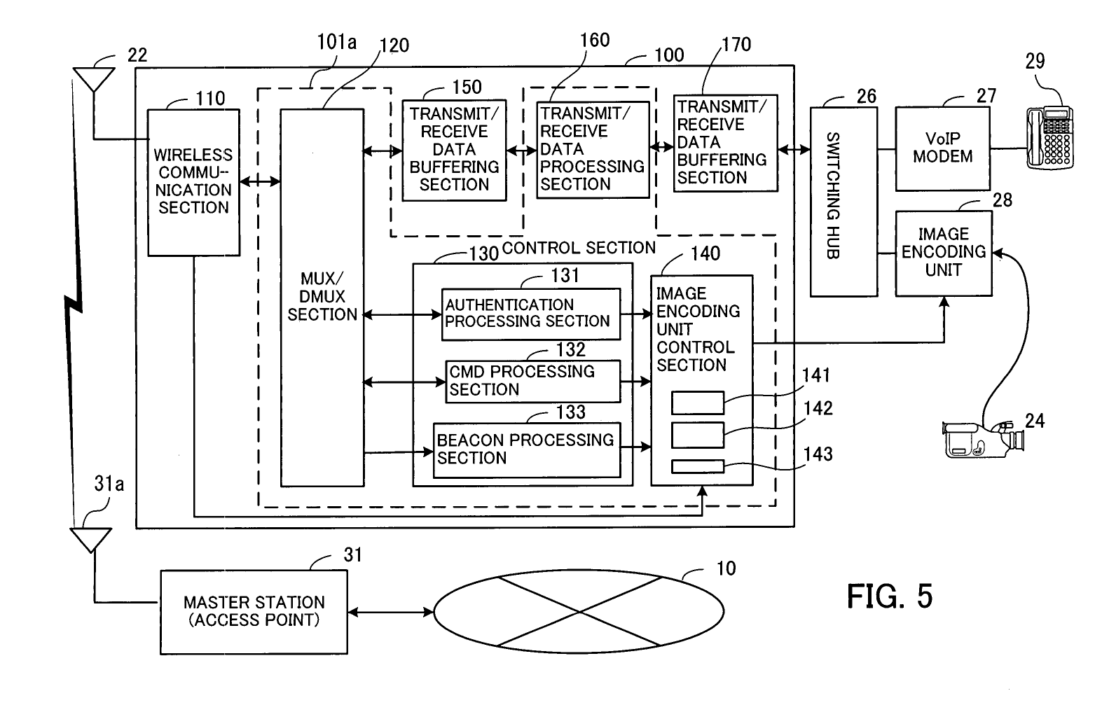

FIG. 5 is a block diagram illustrating the functional configuration of the wireless communication device. In FIG. 5, the wireless network is shown on the left of the wireless communication device 100 and the wired network on the right of same.

In the wireless network, radio wave transmitted from the antenna 22 of the wireless communication device 100 is received by the access point 31 via an antenna 31a. Similarly, radio wave transmitted from the antenna 31a of the access point 31 is received by the wireless communication device 100 through the antenna 22.

In the wired network, the wireless communication device 100 is connected to the switching hub 26 by, for example, 100BASE-TX or the like. The switching hub 26 is connected, as its subordinate devices, with a VoIP modem 27 which makes IP telephony available, and an image encoding unit 28 for transmitting packets of image data.

The VoIP modem 27 is connected with a telephone 29. The VoIP modem 27 converts analog voice information input from the telephone 29 to voice data that can be transmitted by IP technology, and transmits the data to the wireless communication device 100 via the switching hub 26. Also, on receiving voice data transmitted by IP technology from the wireless communication device 100, the VoIP modem 27 converts the received data to analog voice information and transmits the converted information to the telephone 29. This permits a voice call to be established via a wireless network etc.

The wireless communication device 100 comprises a wireless communication section 110, an MUX/DMUX (MUltipleXing/DeMUltipleXing) section 120, a control section 130, an image encoding unit control section 140, a transmit/receive data buffering section 150, a transmit/receive data processing section 160, and a transmit/receive data buffering section 170. The MUX/DMUX section 120, the control section 130, the image encoding unit control section 140 and the transmit/receive data processing section 160 constitute a CPU processing section 101a whose operations are performed by the CPU 101.

The wireless communication section 110 receives signal via the antenna 22 and amplifies and demodulates the The demodulated data is in the form of a data packet sequence, which is transferred to the MUX/DMUX section 120. Also, the wireless communication section 110 modulates signal from the MUX/DMUX section 120 by a method conformable to the IEEE802.11 standard and transmits the modulated signal from the antenna 22. Further, on receiving signal, the wireless communication section 110 detects the receive level of the signal and transfers the detected receive level to the image encoding unit control section 140.

The MUX/DMUX section 120 receives the multiplexed data from the wireless communication section 110 and demultiplexes the received data. Then, the MUX/DMUX section 120 transfers voice data such as VoIP data, and image data such as MPEG data, among the demultiplexed data, to the transmit/receive data buffering section 150. Also, the MUX/DMUX section 120 transfers control frames such as RTS (Request To Send)/CTS (Clear To Send), among the demultiplexed data, to the control section 130. Further, the MUX/DMUX section 120 multiplexes data from the control section 130 and the transmit/receive data buffering section 150 and transfers the multiplexed data to the wireless communication section 110.

The control section 130 controls the communication state by using control packets. Specifically, the control section 130 analyzes control packets received from the MUX/DMUX section 120 and performs an authentication process, command process, beacon process, etc. Also, the control section 130 can transfer data which is to be transmitted to the access point 31, to the MUX/DMUX section 120 as a control packet.

Further, to execute processes in accordance with control packets, the control section 130 includes an authentication processing section 131, a CMD processing section 132, and a beacon processing section 133.

The authentication processing section 131 sends an authentication request at predetermined timings. The authentication request is information by means of which an authentication server or the like, not shown, is requested to authorize the wireless communication device 100 to use the wireless network. If the use of the wireless network is permitted by the authentication server or the like, an authentication result is received as a control packet. The authentication is periodically carried out, so that the wireless communication device 100 can continuously transmit/receive data over the wireless network. While the authentication is performed by the authentication processing section 131, the processing load on the CPU 101 increases.

When a control command is included in a control frame, the CMD processing section 132 performs a process in accordance with the command. For example, on receiving a control frame such as RTS/CTS from the computer 25 etc., the CMD processing section 132 extracts information about media occupation time from the header and sets the information as predetermined control information.

The beacon processing section 133 determines whether or not a beacon signal is included in received control frames. If a beacon signal is included, the beacon processing section 133 notifies the image encoding unit control section 140 of the reception of the beacon signal.

The image encoding unit control section 140 determines the quality of image to be transmitted, in accordance with the amount of processing load on the CPU 101 and the wireless communication state, and then notifies the image encoding unit 28 of the determined image quality. The processing load amount may be determined based on the occupation ratio of the CPU 101, for example, and the wireless communication state may be determined based on the signal level of the beacon signal.

In order to determine the image quality, the image encoding unit control section 140 has a processing load amount-bit rate correspondence table 141 and a receive level-bit rate correspondence table 142. The processing load amount-bit rate correspondence table 141 defines, in terms of bit rate, image qualities matching different processing load amounts, and the receive level-bit rate correspondence table 142 defines, in terms of bit rate, image qualities matching different receive levels.

For example, the image encoding unit control section 140 looks up the processing load amount-bit rate correspondence table 141 and the receive level-bit rate correspondence table 142, to determine a bit rate matching the processing load amount and a bit rate matching the receive level. Then, the image encoding unit control section 140 adopts the smaller one of the two determined bit rates as the image quality to be instructed to the image encoding unit 28. The bit rate indicative of the determined image quality is registered in an instruction set value table 143.

The transmit/receive data buffering section 150 temporarily stores data received from the MUX/DMUX section 120 and then transfers the data to the transmit/receive data processing section 160. Also, the transmit/receive data buffering section 150 temporarily stores data received from the transmit/receive data processing section 160 and transfers the data to the MUX/DMUX section 120.

The transmit/receive data processing section 160 transmits the data stored in the transmit/receive data buffering section 150 to the wired network via the transmit/receive data buffering section 170. Also, the transmit/receive data processing section 160 acquires data which has been written in the transmit/receive data buffering section 170 via the wired network, and transfers the data to the MUX/DMUX section 120 through the transmit/receive data buffering section 150.

The transmit/receive data buffering section 170 temporarily stores data received from the switching hub 26 and transfers the data to the transmit/receive data processing section 160. Also the transmit/receive data buffering section 170 temporarily stores data received from the transmit/receive data processing section 160 and transfers the data to the switching hub 26.

The wireless communication device 100 configured as described above permits delivery of image captured by the camera 24 as well as voice call based on VoIP etc. The following describes processes of the wireless communication device 100.

First, the flow of data from the access point 31 to the wireless communication device 100 will be explained. The wireless communication device 100 receives, through the antenna 22, data transmitted from the access point 31. The data received by the antenna 22 is amplified and demodulated in the wireless communication section 110 by a method conformable to the IEEE802.11 standard to obtain a data packet sequence, which is then transferred to the MUX/DMUX section 120. At this time, the wireless communication section 110 detects the receive level. Information on the detected receive level is supplied to the image encoding unit control section 140.

The MUX/DMUX section 120 sorts the received data such that a sequence of data such as VoIP data is sent to the transmit/receive data buffering section 150. The transmit/receive data buffering section 150 stores the received packets, waiting for the processing by the transmit/receive data processing section 160. The stored packets are then successively sent to the transmit/receive data processing section 160.

In the transmit/receive data processing section 160, the packets are processed such that the header for wireless communication is replaced by a header for wired communication. After passing through the transmit/receive data processing section 160, the packets are temporarily stored in the transmit/receive data buffering section 170, waiting for delivery to the wired network via 100BASE-TX etc., and then sent to the switching hub 26 through a cable.

On the other hand, a control frame such as RTS/CTS is transferred from the MUX/DMUX section 120 to the CMD processing section 132, where a process is performed in accordance with the content of the control frame. At this time, the beacon processing section 133 determines whether or not a beacon signal is included in the control frame. If a beacon signal is included, the image encoding unit control section 140 is notified of the reception of the beacon signal. The image encoding unit control section 140 determines the quality of image to be delivered, in accordance with the receive level detected at the time of detection of the beacon signal, and supplies information specifying the image quality to the image encoding unit 28. Thereupon, the image encoding unit 28 encodes image information from the camera 24 to obtain image data of the instructed quality.

Data flow from the wireless communication device 100 to the access point 31 will be now described. When VoIP data or image data (e.g., MPEG2 data) is received from the wired network side, the wireless communication device 100 once stores the received data in the transmit/receive data buffering section 170. The stored data is then successively sent to the transmit/receive data processing section 160.

In the transmit/receive data processing section 160, each data packet is processed such that the header for wired communication is replaced with a header for wireless communication. Then, the data is stored in the transmit/receive data buffering section 150, waiting for an interrupt process of the control section 130, and transferred to the MUX/DMUX section 120.

The MUX/DMUX section 120 multiplexes the received data with other control packets etc. and transfers the multiplexed data to the wireless communication section 110, whereupon the wireless communication section 110 modulates the multiplexed data and transmits the modulated data from the antenna 22.

When authentication is required, a control frame for authentication is generated in the authentication processing section 131 of the control section 130. The generated control frame is transferred as an interrupt process to the MUX/DMUX section 120, then multiplexed with other data and transmitted. In the case of using MD5 Challenge-Response authentication, for example, an authentication request is generated in the authentication processing section 131 and transmitted to an authentication server. On receiving a random number called MD5-Challenge from the authentication server, the authentication processing section 131 encrypts the random number by using MD5 algorithm and transmits the encrypted data to the authentication server.

With the image encoding unit 28 connected to the wireless communication device 100 as shown in FIG. 5, if any process needs to be performed by the authentication processing section 131, CMD processing section 132, etc. of the wireless communication device 100 while image data is bursting at high bit rate from the image encoding unit 28, the processing load on the CPU 101 increases. If the load is excessively large, the image data overflows in the transmit/receive data buffering section 150, possibly causing loss of packets.

Accordingly, in the first embodiment, the amount of processing load of the wireless communication device 100 is calculated and the result is supplied to the image encoding unit control section 140 as status information. Based on the status information and the receive level information received from the wireless communication section 110, the image encoding unit control section 140 instructs the image encoding unit 28 to change the bit rate.

For example, when the wireless communication device 100 is moved from the coverage of one access point to the coverage of another, a subroutine for the authentication process is started (authentication processing section 131 is a process that executes the subroutine). When entering the subroutine for the authentication process, the image encoding unit control section 140 measures the amount of processing load imposed on the wireless communication device 100.

The image encoding unit control section 140 then looks up the processing load amount-bit rate correspondence table 141 to determine a bit rate matching the measured amount of processing load.

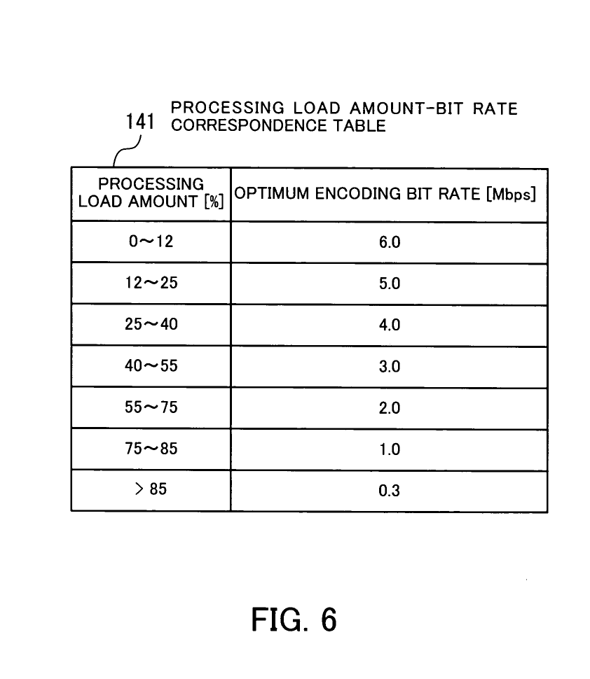

FIG. 6 illustrates an exemplary data structure of the processing load amount-bit rate correspondence table. In the processing load amount-bit rate correspondence table 141, processing load amounts and optimum encoding bit rates are registered in a manner associated with each other.

The processing load amount is expressed in terms of CPU occupation ratio (%). The CPU occupation ratio is a ratio of time that the CPU spends on data processing to unit time.

The optimum encoding bit rate, which is expressed in Mbps, indicates to what amount of digital data image data per unit time is to be converted when image is encoded. Accordingly, the higher the bit rate, the larger the amount of encoded data, so that the image quality increases.

In the example of FIG. 6, the optimum encoding bit rate is set to 6.0 Mbps when the processing load amount is 0 to 12%. For a processing load amount of 12 to 25%, the optimum encoding bit rate is set to 5.0 Mbps, for a processing load amount of 25 to 40%, the optimum encoding bit rate is set to 4.0 Mbps, for a processing load amount of 40 to 55%, the optimum encoding bit rate is set to 3.0 Mbps, for a processing load amount of 55 to 75%, the optimum encoding bit rate is set to 2.0 Mbps, for a processing load amount of 75 to 85%, the optimum encoding bit rate is set to 1.0 Mbps, and for a processing load amount of over 85%, the optimum encoding bit rate is set to 0.3 Mbps.

Thus, the processing load amount-bit rate correspondence table 141 is looked up to determine image quality matching the processing load amount, whereby the image quality can be set so as to lower with increase in the processing load.

Also, the image encoding unit control section 140 determines image quality matching the wireless communication state (receive level). The receive level of wireless channel can be determined from the receive level of a beacon signal received from the target of communication. Whether the received beacon signal is from the target of communication or not is determined by the beacon processing section 133, and if the beacon signal is from the target of communication, the image encoding unit control section 140 is notified of reception of the beacon signal.

When the beacon signal is detected, the image encoding unit control section 140 acquires the receive level information then supplied from the wireless communication section 10. Subsequently, the image encoding unit control section 140 looks up the receive level-bit rate correspondence table 142 to determine optimum encoding bit rate matching the acquired receive level.

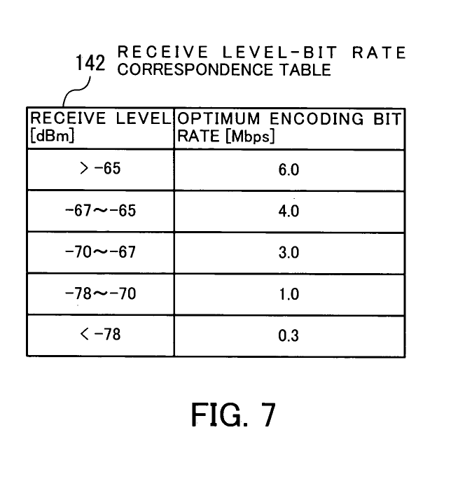

FIG. 7 illustrates an exemplary data structure of the receive level-bit rate correspondence table. In the receive level-bit rate correspondence table 142, receive levels and optimum encoding bit rates are registered in a manner associated with each other.

The receive level is expressed in dBm, where dBm is a tenfold value of the common logarithm of a value which indicates the received signal strength in mW (milliwatt).

The optimum encoding bit rate, which is expressed in Mbps, indicates to what amount of digital data image data per unit time is to be converted when image is encoded.

In the example of FIG. 7, the optimum encoding bit rate is set to 6.0 Mbps when the receive level is over −65 dBm. For a receive level of −67 to −65 dBm, the optimum encoding bit rate is set to 4.0 Mbps, for a receive level of −70 to −67 dBm, the optimum encoding bit rate is set to 3.0 Mbps, for a receive level of −78 to −70 dBm, the optimum encoding bit rate is set to 1.0 Mbps, and for a receive level lower than −78 dBm, the optimum encoding bit rate is set to 0.3 Mbps.

Thus, the image encoding unit control section 140 looks up both the processing load amount-bit rate correspondence table 141 and the receive level-bit rate correspondence table 142 to determine a bit rate to be instructed to the image encoding unit 28. The determined bit rate is set in the instruction set value table 143.

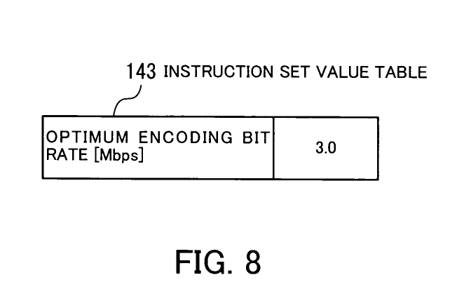

FIG. 8 illustrates an exemplary data structure of the instruction set value table. As shown in FIG. 8, the optimum encoding bit rate to be instructed to the image encoding unit 28 is set in the instruction set value table 143. In the illustrated example, 3.0 Mbps is set as the bit rate.

A procedure for determining the optimum encoding bit rate will be now described in more detail.

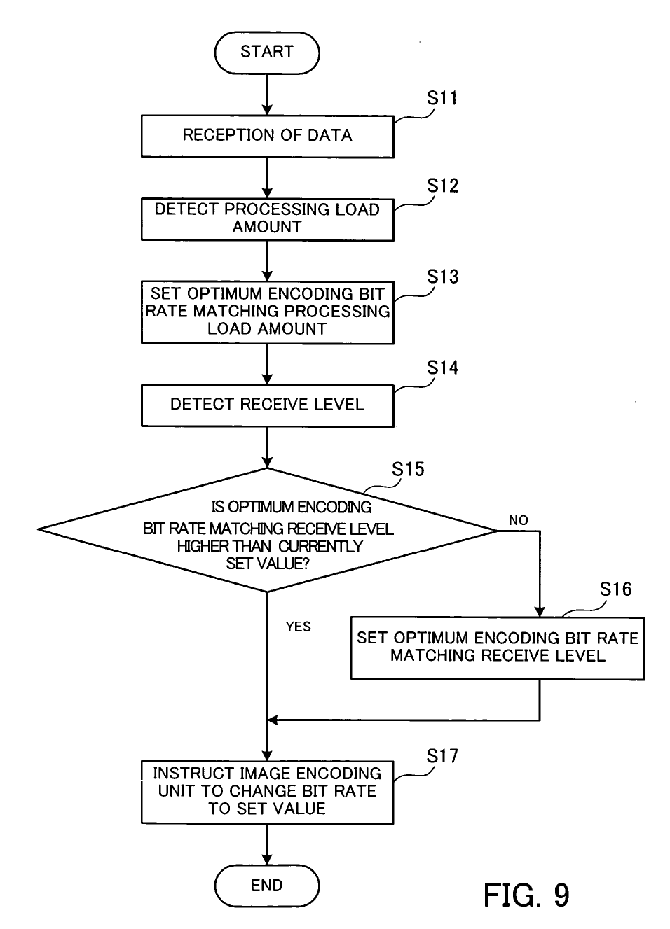

FIG. 9 is a flowchart illustrating the optimum encoding bit rate decision procedure. In the following, the process shown in FIG. 9 will be explained in order of step number.

[Step S11] The image encoding unit control section 140 acquires information indicating reception of predetermined data, such as a beacon signal, from the control section 130, whereupon the process proceeds to Step S12.

[Step S12] The image encoding unit control section 140 detects the amount of processing load on the CPU 101.

[Step S13] The image encoding unit control section 140 looks up the processing load amount-bit rate correspondence table 141 to determine an optimum encoding bit rate matching the processing load amount detected in Step S12. Then, the image encoding unit control section 140 sets the determined value in the instruction set value table 143.

[Step S14] The image encoding unit control section 140 detects the receive level supplied from the wireless communication section 110.

[Step S15] The image encoding unit control section 140 looks up the receive level-bit rate correspondence table 142 to determine an optimum encoding bit rate matching the receive level detected in Step S14. It is then determined whether or not the optimum encoding bit rate matching the receive level is higher than the value currently set in the instruction set value table 143. If the optimum encoding bit rate matching the receive level is higher than the set value, the process proceeds to Step S17; if the optimum encoding bit rate matching the receive level is lower than the set value, the process proceeds to Step S16.

[Step S16] The image encoding unit control section 140 sets the optimum encoding bit rate matching the receive level in the instruction set value table 143.

[Step S17] The image encoding unit control section 140 instructs the image encoding unit 28 to change the bit rate to the value set in the instruction set value table 143.

In this manner, of the two optimum encoding bit rates respectively matching the processing load and the receive level, the lower one is set in the instruction set value table 143, and the value set in the instruction set value table 143 is provided as an instruction to the image encoding unit 28. Consequently, the image encoding unit 28 encodes image from the camera 24 at the instructed bit rate and transmits the encoded image to the wireless communication device 100.

By following the aforementioned procedure, it is possible to determine an optimum encoding bit rate matching the processing load amount as well as the receive level and to provide the image encoding unit 28 with the determined bit rate as an instruction.

The relationship between the processing load amount and the optimum encoding bit rate will be now explained.

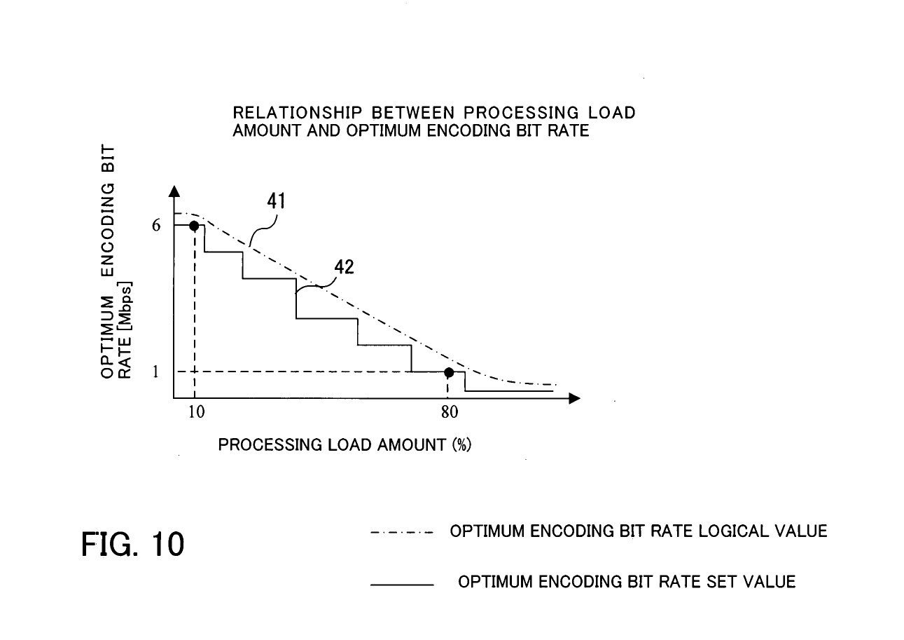

FIG. 10 illustrates the relationship between the processing load amount and the optimum encoding bit rate. The graph of FIG. 10 shows values of optimum encoding bit rates set with respect to different processing load amounts in the case where the receive level is sufficiently high (in best condition). In the graph, the horizontal axis indicates the processing load amount and the vertical axis indicates the optimum encoding bit rate.

In FIG. 10, dot-dash line 41 indicates an optimum encoding bit rate logical value matching the processing load amount, and solid line 42 indicates an optimum encoding bit rate set value to which the bit rate is actually set in accordance with the processing load amount.

As illustrated, the optimum encoding bit rate logical value gradually decreases with increase in the processing load amount. Thus, the optimum encoding bit rate set value is set so as to be slightly smaller than the optimum encoding bit rate logical value. The optimum encoding bit rate set value is determined based on the processing load amount-bit rate correspondence table 141 and, accordingly, decreases stepwise with increase in the processing load amount.

When the processing load amount is 10%, for example, the optimum encoding bit rate set value is 6 Mbps, and when the processing load amount is 80%, the optimum encoding bit rate set value is 1 Mbps.

The following explains how the optimum encoding bit rate set value changes according to the receive level. It is assumed here that, as shown in FIG. 2, image of the river 21 is delivered while the vehicle 23 equipped with the wireless communication device 100 moves on the road 20 along which the access points 31, 32, 33, 34, . . . are installed. In this case, as the vehicle 23 approaches an access point, the receive level of the beacon signal rises, and as the vehicle 23 moves away from the access point, the receive level of the beacon signal lowers. Consequently, the receive level alternately rises and falls with lapse of time.

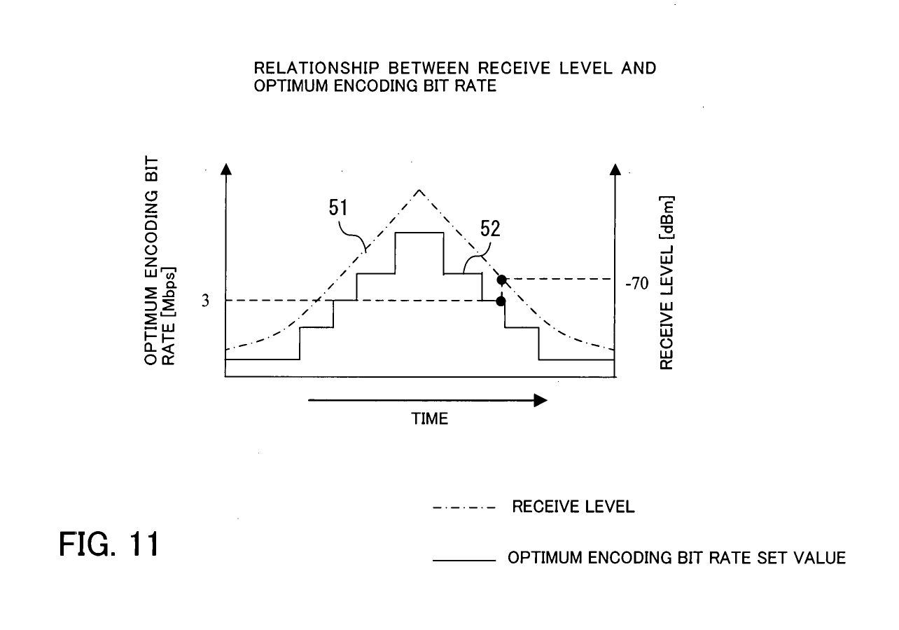

FIG. 11 illustrates the relationship between the receive level and the optimum encoding bit rate. The graph of FIG. 11 shows change in the receive level with time as well as change in the optimum encoding bit rate matching the receive level. In the graph, the horizontal axis indicates time, and the vertical axes indicate the receive level (of which the unit is indicated on the right side of the graph) and the optimum encoding bit rate (of which the unit is indicated on the left side of the graph). It is assumed that the processing load is considerably low.

In FIG. 11, dot-dash line 51 indicates the receive level, and solid line 52 indicates the optimum encoding bit rate set value to which the bit rate is actually set in accordance with the receive level.

As the vehicle 23 approaches an access point with lapse of time, the receive level increases, and at the point where the vehicle 23 is nearest the access point, the receive level which has been increasing until then begins to decrease. Then, as the vehicle 23 moves away from the access point with lapse of time, the receive level gradually decreases.

The optimum encoding bit rate set value is determined in accordance with the receive level. When the receive level is −70 dBm, for example, the optimum encoding bit rate set value is 3 Mbps. Also, the optimum encoding bit rate set value is increased stepwise while the receive level is increasing, and is decreased stepwise while the receive level is decreasing.

In this manner, the image encoding unit control section 140 can obtain an optimum encoding bit rate matching the processing load amount and an optimum encoding bit rate matching the receive level. Of the two optimum encoding bit rates thus obtained, the lower one is provided as an instruction to the image encoding unit 28.

The processing load amount dynamically varies depending on the content of process executed in the wireless communication device 100.

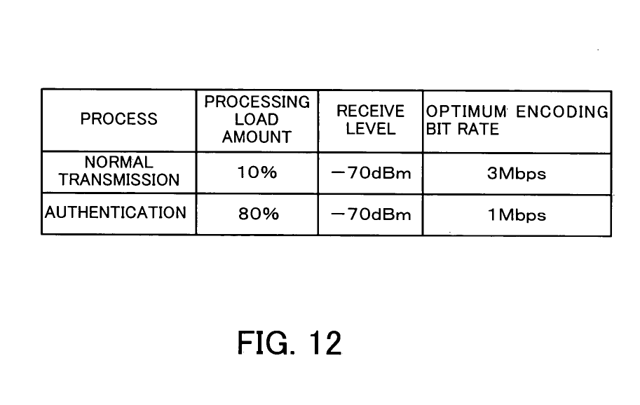

FIG. 12 shows optimum encoding bit rates matching respective combinations of processing load amount and receive level. In FIG. 12, the processing load amount increases from 10% to 80% as a result of change of process from normal process to authentication process, while the receive level remains at the same level −70 dBm.

The processing load amount-bit rate correspondence table 141 shown in FIG. 6 indicates that the optimum encoding bit rate for the normal-state processing load amount 10% is 6 Mbps. On the other hand, the receive level-bit rate correspondence table 142 shown in FIG. 7 indicates that the optimum encoding bit rate for the receive level −70 dBm is 3 Mbps. Accordingly, the image encoding unit control section 140 instructs the image encoding unit 28 to transmit data at the bit rate 3 Mbps.

When the authentication process is started, the processing load amount increases to 80%. The processing load amount-bit rate correspondence table 141 of FIG. 6 indicates that the optimum encoding bit rate is 1 Mbps, while the receive level-bit rate correspondence table 142 of FIG. 7 indicates that the optimum encoding bit rate for the receive level −70 dBm is 3 Mbps. Accordingly, the image encoding unit control section 140 instructs the image encoding unit 28 to decrease the bit rate to 1 Mbps.

Decreasing the encoding bit rate of the image encoding unit 28 means decreasing the amount of data to be processed by the wireless communication device 100. Thus, even while the processing load on the wireless communication device 100 is high, the CPU occupation time necessary for the delivery of image data can be secured.

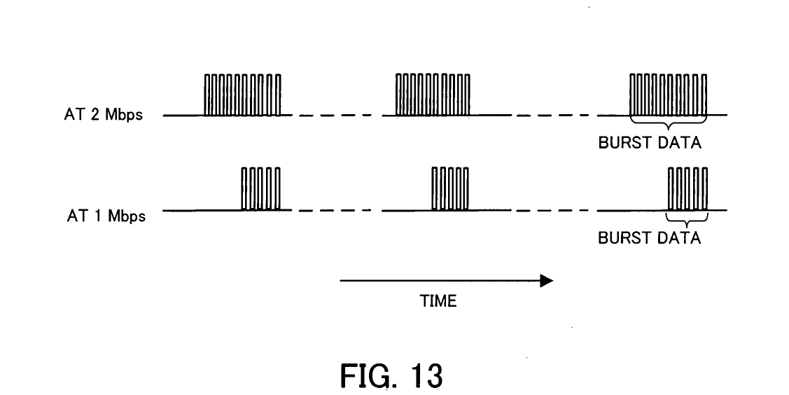

FIG. 13 illustrates flows of image data transmitted from the image encoding unit, wherein the upper row shows an image data flow at an encoding bit rate of 2 Mbps and the lower row shows an image data flow at an encoding bit rate of 1 Mbps.

According to MPEG2, image data is transferred in blocks of burst data. The amount of burst data transferred at a time when the bit rate is 1 Mbps is half that of burst data transferred at a time when the bit rate is 2 Mbps.

By reducing the burst data amount, it is possible to allocate the capacity of the CPU 101 of the wireless communication device 100 to other processes than the image delivery. Also, by decreasing the encoding bit rate when the processing load is high, it is possible to transmit image without reducing the number of frames thereof.

In this manner, the delivery of image packets is dynamically and preferentially controlled in accordance with the amount of processing load on the device and the receive level of radio signal so as to prevent image frame drop, whereby efficient transmission suited to the external/internal environments can be carried out.

[Second Embodiment]

A second embodiment will be now described. In the second embodiment, a future wireless communication state is predicted based on the manner of how the wireless communication state has changed, and the image quality is set in accordance with the predicted wireless communication state.

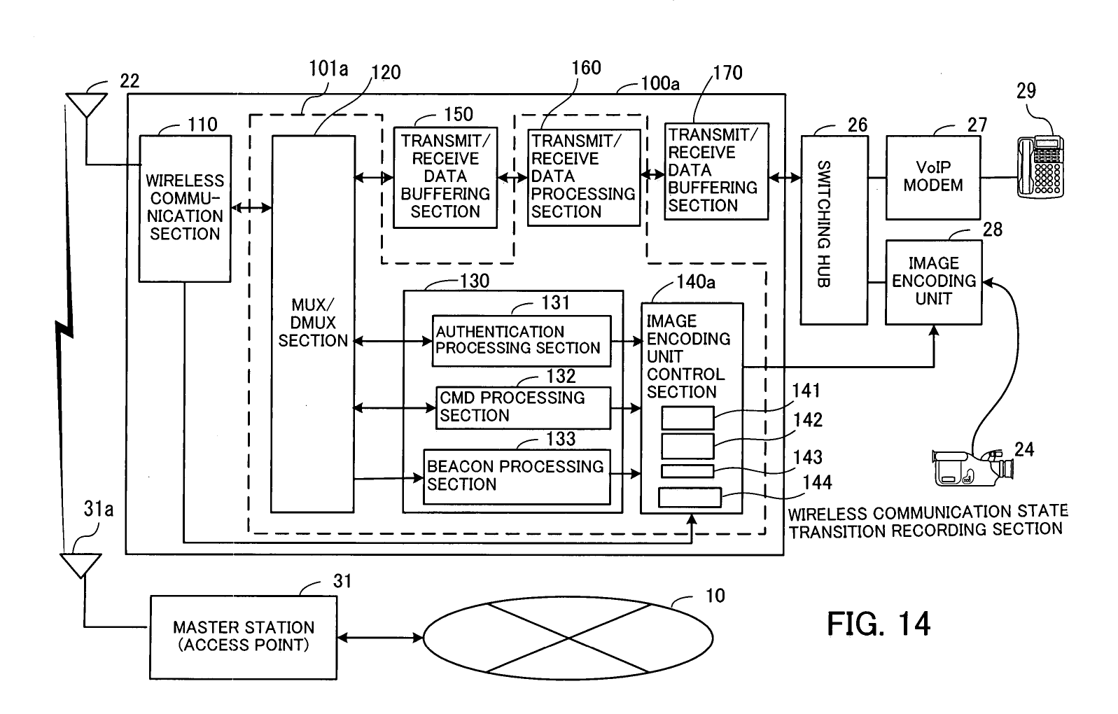

FIG. 14 is a block diagram illustrating an internal configuration of a wireless communication device according to the second embodiment. The wireless communication device 100a of the second embodiment differs from the counterpart of the first embodiment shown in FIG. 5 only in the function of an image encoding unit control section 140a. Accordingly, in FIG. 14, identical reference numerals are used to denote elements having the same functions as those of the first embodiment shown in FIG. 5, and explanation of such elements is omitted.

Also, it is assumed that the contents of the processing load amount-bit rate correspondence table 141 are identical with those shown in FIG. 6, and that the contents of the receive level-bit rate correspondence table 142 are identical with those shown in FIG. 7.

The image encoding unit control section 140a appearing in FIG. 14 additionally includes a wireless communication state transition recording section 144. The wireless communication state transition recording section 144 records the receive level information supplied from the wireless communication section 110 in a receive level transition table thereof, and predicts a subsequent wireless communication state on the basis of the receive level transition. Then, the image encoding unit control section 140a determines an optimum encoding bit rate in accordance with the predicted wireless communication state, and informs the image encoding unit 28 of the determined bit rate.

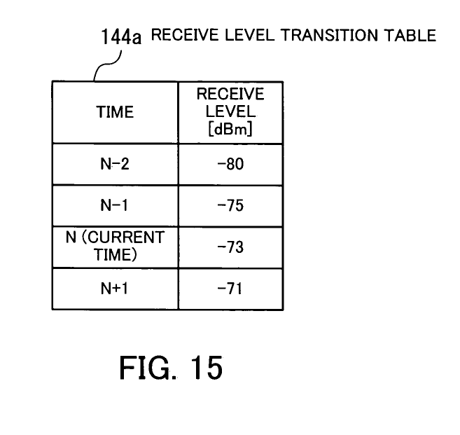

FIG. 15 illustrates an exemplary data structure of the receive level transition table. Each time the beacon signal is received, the receive level thereof is recorded in the receive level transition table 144a. In FIG. 15, the time (current time) of measurement of the latest receive level is indicated by tN (N is a natural number incremented each time the receive level is measured), where t is the time period indicative of a receive level measurement interval (beacon signal reception interval). The time at which the receive level was measured before the time tN is indicated by t(N−1), the time at which the receive level was measured before the time t(N−1) is indicated by t(N−2), and the time at which the receive level is to be measured next is indicated by t(N+1).

In the example shown in FIG. 15, the receive level measurement result at the time t(N−2) is −80 dBm, the receive level measurement result at the time t(N−1) is −75 dBm, and the receive level measurement result at the time tN is −73 dBm.

Using the receive level transition table 144a configured in this manner, the receive level of near future, that is, the receive level at the time t(N+1), is predicted on the basis of the past three receive levels measured at the times tN, t(N−1), and t(N−2). The predicted value is registered in association with the time t(N+1). In the example of FIG. 15, the predicted value is −71 dBm.

An optimum encoding bit rate decision procedure employed in the configuration shown in FIG. 14 will be now described.

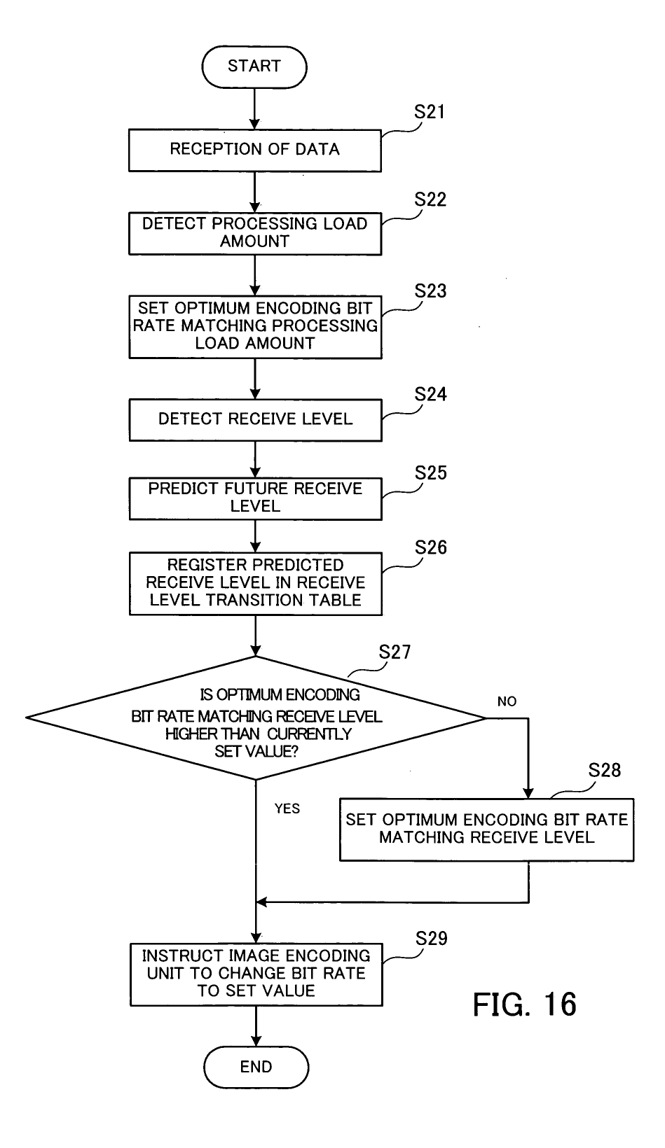

FIG. 16 is a flowchart illustrating the optimum encoding bit rate decision procedure according to the second embodiment. In the following, the process shown in FIG. 16 will be explained in order of step number.

[Step S21] The image encoding unit control section 140a acquires information indicating reception of predetermined data, such as a beacon signal, from the control section 130, whereupon the process proceeds to Step S22.

[Step S22] The image encoding unit control section 140a detects the amount of processing load on the CPU 101.

[Step S23] The image encoding unit control section 140a looks up the processing load amount-bit rate correspondence table 141 to determine an optimum encoding bit rate matching the processing load amount detected in Step S22. Then, the image encoding unit control section 140a sets the determined value in the instruction set value table 143.

[Step S24] The image encoding unit control section 140a detects the receive level supplied from the wireless communication section 110.

[Step S25] The image encoding unit control section 140a predicts a future receive level. For example, the image encoding unit control section 140a predicts the receive level of near future on the bases of the past three receive levels.

[Step S26] The image encoding unit control section 140a registers the predicted value, calculated in Step S25, in the receive level transition table 144a as the receive level at the time t(N+1).

[Step S27] The image encoding unit control section 140a looks up the receive level-bit rate correspondence table 142 to determine an optimum encoding bit rate matching the predicted value of receive level, registered in Step S26. Then, the image encoding unit control section 140a determines whether or not the determined optimum encoding bit rate is higher than the value currently set in the instruction set value table 143. If the optimum encoding bit rate matching the predicted receive level is higher than the set value, the process proceeds to Step S29; if the optimum encoding bit rate matching the predicted receive level is lower than the set value, the process proceeds to Step S28.

[Step S28] The image encoding unit control section 140a sets the optimum encoding bit rate matching the predicted receive level in the instruction set value table 143.

[Step S29] The image encoding unit control section 140a instructs the image encoding unit 28 to change the bit rate to the value set in the instruction set value table 143.

In this manner, the wireless communication state of near future is predicted based on the transition of wireless communication state, and the information on the predicted state is reflected in the decision of the optimum encoding bit rate, whereby image packets can be transmitted in a manner more suited to the current conditions.

A method of predicting the wireless communication state will be now described in detail. In the following description, it is assumed that the receive levels at the times tN, t(N−1) and t(N−2) are PN, P(N−1), and P(N−2), respectively.

In the case where the receive level shows a tendency to rise with lapse of time (P(N−2)<P(N−1)<PN), it is determined whether the upward tendency of the receive level is becoming gentler or steeper. Then, the receive level P(N+1) at the time t(N+1) is predicted on the basis of the degree of change of the upward tendency.

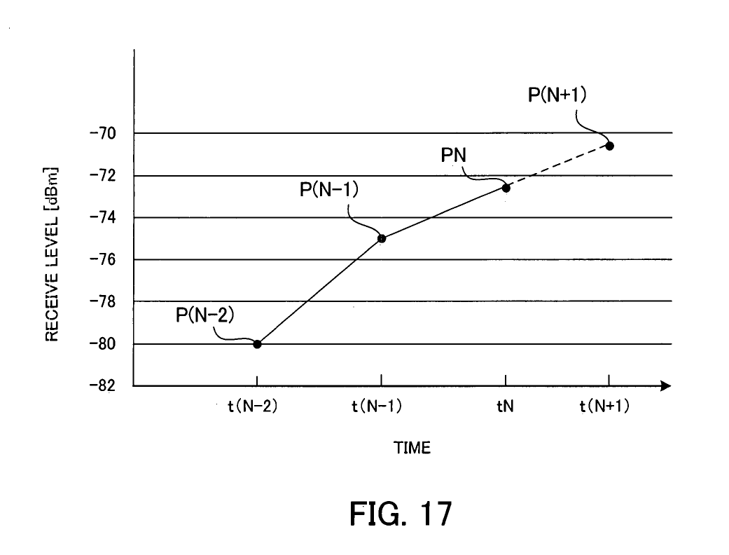

FIG. 17 illustrates an example of how the receive level is predicted, wherein the horizontal axis indicates time and the vertical axis indicates receive level.

In FIG. 17, it is assumed that the line between P(N−2) and P(N−1) has a gradient a1 and that the line between P(N−1) and PN has a gradient a2. In the case where the receive level has undergone the state transition as shown in FIG. 15, for example, a1=5 and a2=2; therefore, a1>a2, indicating that the upward tendency is becoming gentler. In this case, it is assumed that the upward tendency is maintained as it is. Accordingly, the predicted value P(N+1) is calculated on the assumption that the gradient a3 of the line between PN and P(N+1) equals a2 (a3=a2).

Where a1<a2, it can be concluded that the upward tendency is becoming steeper. If, in this case, it is assumed that the upward tendency remains as steep as it is, the predicted receive level turns out to be much higher than the actual level. If the predicted receive level is much higher than the actual receive level, omission of packets or the like can possibly occur. To prevent this, the gradient a3 of the line between PN and P(N+1) is predicted such that a3=(a1+a2)/2, and not a3=a2, is fulfilled. Following this procedure, P(N+1) is predicted.

In the case where the receive level shows a tendency to lower with lapse of time (P(N−2)>P(N−1)>PN), the predicted value P(N+1) is calculated on the assumption that the downward tendency is maintained as it is and thus that the gradient a3 of the line between PN and P(N +1) equals a2 (a3=a2), provided the gradient of the line between P(N−2) and P(N−1) is a1 and the gradient of the line between P(N−1) and PN is a2.

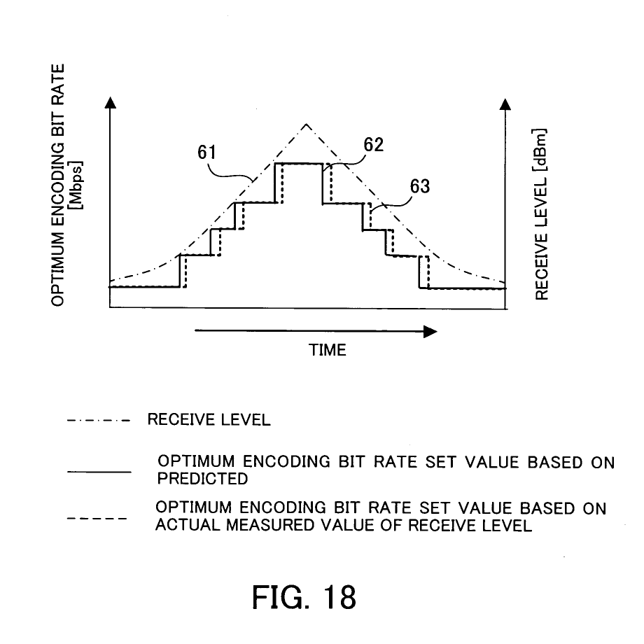

FIG. 18 is a graph illustrating the relationship between the predicted receive level and the optimum encoding bit rate corresponding thereto, wherein the horizontal axis indicates time and the vertical axes indicate the receive level and the optimum encoding bit rate.

In FIG. 18, dot-dash line 61 indicates the receive level, solid line 62 indicates an optimum encoding bit rate set value which is based on the predicted value of receive level, and dotted line 63 indicates an optimum encoding bit rate set value which is based on the actual measured value of receive level. The optimum encoding bit rate set value based on the actual measured value of receive level is illustrated by way of reference only and is not used in the second embodiment.

In this manner, the wireless communication state of near future is predicted on the basis of the transition of wireless communication state, and the information on the predicted state is reflected in the decision of the optimum encoding bit rate, whereby image packets can be transmitted in a manner more suited to the current conditions. Specifically, where the receive level shows an upward tendency, the optimum encoding bit rate is increased at earlier timing than in the first embodiment, and where the receive level shows a downward tendency, the optimum encoding bit rate is decreased at earlier timing than in the first embodiment. Consequently, the optimum encoding bit rate can be set so as to match the wireless communication state within a time period from the measurement of the receive level following the reception of a beacon signal to the next measurement of the receive level (time period during which the receive level is not measured).

In the case where the actual receive level is lower than the predicted value, the set optimum encoding bit rate turns out to be higher than the optimum encoding bit rate that should actually be set, possibly causing omission of packets as a result. To prevent such inconvenience, a margin may be provided in the relationship between the receive level and the optimum encoding bit rate set in accordance therewith.

[Third Embodiment]

According to a third embodiment, the wireless communication state is judged by CRC error in the beacon signal.

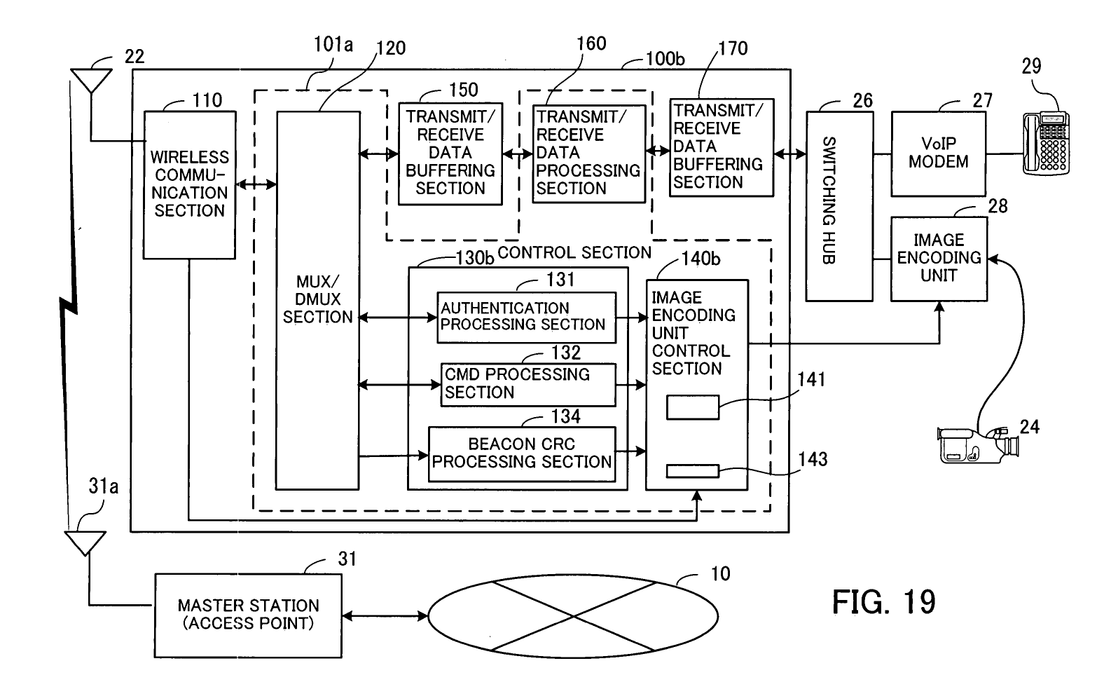

FIG. 19 is a block diagram illustrating a functional configuration of a wireless communication device according to the third embodiment. The wireless communication device 100b of the third embodiment differs from the counterpart of the first embodiment shown in FIG. 5 only in the functions of a wireless communication section 110a, control section 130a and image encoding unit control section 140b. Accordingly, in FIG. 19, identical reference numerals are used to denote elements having the same functions as those of the first embodiment shown in FIG. 5 and explanation of such elements is omitted.

Also, it is assumed that the contents of the processing load amount-bit rate correspondence table 141 are identical with those shown in FIG. 6.

The wireless communication section 110a functions in the same manner as the wireless communication section 110 of the first embodiment, but does not have the function of supplying the receive level information to the image encoding unit control section 140b.

The control section 130a includes a beacon CRC processing section 134, in place of the beacon processing section 133 of the first embodiment. The beacon CRC processing section 134 detects CRC error in the beacon signal.

For example, the beacon signal is transmitted at the same rate as a data frame, and the beacon frame has a length of 24 Bytes when the data frame is 1518 Bytes long. The beacon CRC processing section 134 determines whether or not the received beacon signal is from the target of communication and, if the beacon signal is from the target of communication, detects CRC error in the beacon signal. On detecting CRC error, the beacon CRC processing section 134 notifies the image encoding unit control section 140b of the detection of error.

The image encoding unit control section 140b determines an optimum encoding bit rate in accordance with the processing load and the CRC error. Then, the image encoding unit control section 140b instructs the image encoding unit 28 to encode image data at the determined optimum encoding bit rate. Unlike the image encoding unit control section 140 of the first embodiment, the image encoding unit control section 140b of the third embodiment does not have the receive level-bit rate correspondence table 142.

Specifically, when notified of the detection of CRC error, the image encoding unit control section 140b judges that the current wireless communication state is poor. In this case, the image encoding unit control section 140b decreases the value set in the instruction set value table 143, so that the image encoding unit 28 is instructed to lower the bit rate.

When the wireless communication state has recovered, the bit rate is returned to a higher rate in the manner described below. The beacon CRC processing section 134 has the function of counting the number of CRC checks and the number of errors. In order to transmit 1518 Bytes of data free of error, the channel should guarantee that no bit error occurs in 121,440 bits (=1518×10×8), and to check the error rate of 1518-Byte data by means of a 24-Byte beacon signal, CRC check is performed on 633 (=(1518×10) ÷24) beacon signals. Thus, the beacon CRC processing section 134 performs CRC check on 633 beacon signals and, if no error is detected, supplies the image encoding unit control section 140b with information indicating zero error detection. On receiving the information, the image encoding unit control section 140b judges that the wireless communication state has recovered, and therefore, instructs the image encoding unit 28 to raise the bit rate.

An optimum encoding bit rate decision procedure will be now described in detail.

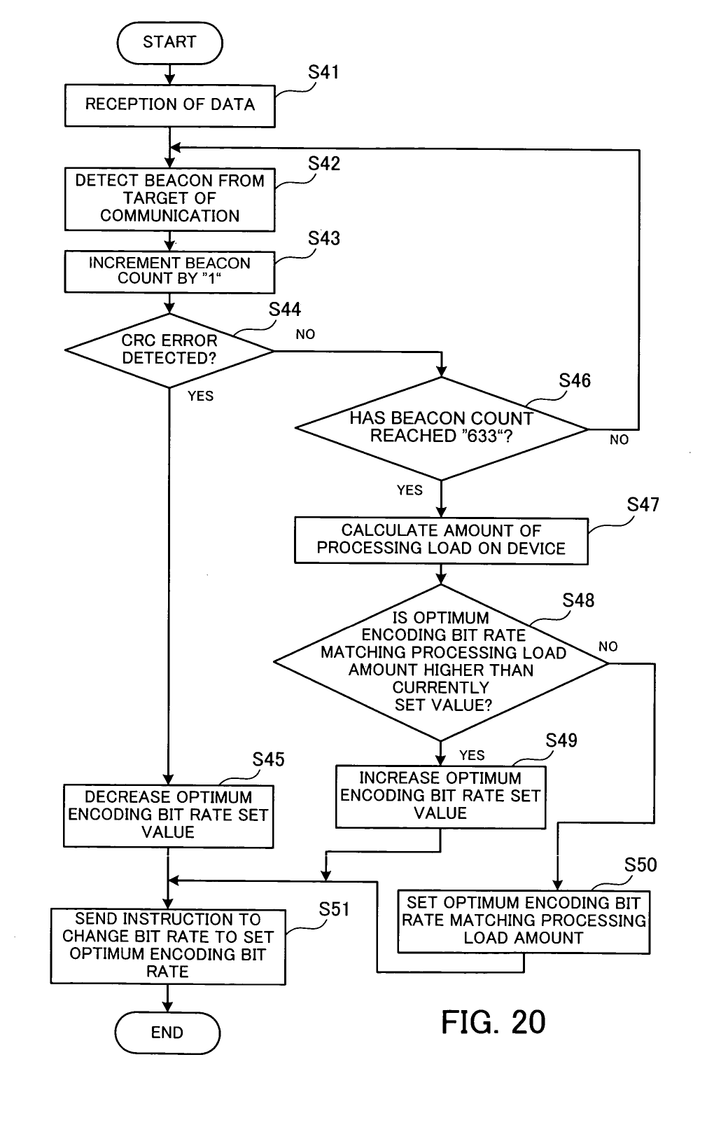

FIG. 20 is a flowchart illustrating the optimum encoding bit rate decision procedure according to the third embodiment. In the following, the process shown in FIG. 20 will be explained in order of step number.

[Step S41] The control section 130a receives data, whereupon the process proceeds to Step S42.

[Step S42] The beacon CRC processing section 134 detects a beacon signal transmitted from the target of communication.

[Step S43] The beacon CRC processing section 134 increments a beacon count by “1”.

[Step S44] The beacon CRC processing section 134 detects CRC error of the beacon signal. If a CRC error is detected, the process proceeds to Step S45; if no CRC error is detected, the process proceeds to Step S46.

[Step S45] The beacon CRC processing section 134 decreases the optimum encoding bit rate set in the instruction set value table 143. The process then proceeds to Step S51.

[Step S46] The beacon CRC processing section 134 determines whether or not the beacon count has reached “633”. If the beacon count has reached “633”, the process proceeds to Step S47; if the beacon count has not reached “633” yet, the process proceeds to Step S42 to detect a next beacon signal.

[Step S47] The image encoding unit control section 140b calculates the amount of processing load on the wireless communication device 100b.

[Step S48] The image encoding unit control section 140b looks up the processing load amount-bit rate correspondence table 141 to determine an optimum encoding bit rate matching the processing load amount. Then, the image encoding unit control section 140b determines whether the optimum encoding bit rate matching the processing load amount is higher or lower than the optimum encoding bit rate set in the instruction set value table 143. If the optimum encoding bit rate matching the processing load amount is higher than the set optimum encoding bit rate, the process proceeds to Step S49; if the optimum encoding bit rate matching the processing load amount is lower than or equal to the set optimum encoding bit rate, the process proceeds to Step S50.

[Step S49] The image encoding unit control section 140b increases the optimum encoding bit rate set in the instruction set value table 143. The process then proceeds to Step S51.

[Step S50] The image encoding unit control section 140b sets the optimum encoding bit rate matching the processing load amount in the instruction set value table 143.

[Step S51] The image encoding unit control section 140b instructs the image encoding unit 28 to change the bit rate to the value set in the instruction set value table 143.

Thus, the wireless communication state is judged by CRC error so that image data can be encoded at a bit rate matching the wireless communication state.

In this connection, Japanese Unexamined Patent Publication No. 11-308297 discloses measuring the error rate of data and increasing/decreasing the amount of transmit data in accordance with control information generated based on the measured error rate. In the system disclosed in this publication, the receiving side has the function of measuring the error rate of data and generating control information, while the transmitting side receives the information and increases/decreases the amount of image data to be transmitted. The third embodiment of the present invention differs from Japanese Unexamined Patent Publication No. 11-308297 in that the measurement of the error rate of data is carried out at the image transmitting side and has nothing to do with the receiving-side device.

Thus, information about CRC error detected in the beacon signal is used as a parameter indicative of the wireless communication state, whereby the circuitry configuration can be simplified, compared with the case of judging the wireless communication state on the basis of receive level information.

[Other Exemplary Applications]

In the foregoing embodiments, the image encoding unit 28 and the camera 24 are connected externally to the wireless communication device but may alternatively be built into the wireless communication device.

Also, change in the past wireless communication state (judged from the receive level or CRC error) with time may be learned so as to predict a future wireless communication state. For example, the wireless communication state (best wireless communication state) detected when the wireless communication device is nearest an access point is stored, and in this case, it is possible to predict that the wireless communication state becomes poorer (e.g., the receive level lowers) after reaching the best wireless communication state.

The processing functions described above can be performed by a computer. In this case, a program is prepared in which are described processes for performing the functions of the wireless communication device. The program is executed by a computer, whereupon the aforementioned processing functions are accomplished by the computer. The program describing the required processes may be recorded on a computer-readable recording medium. The computer-readable recording medium includes a magnetic recording device, an optical disc, a magneto-optical recording medium, a semiconductor memory, etc. The magnetic recording device may be a hard disk drive (HDD), a flexible disk (FD), a magnetic tape or the like. As the optical disc, a DVD (Digital Versatile Disc), a DVD-RAM (Random Access Memory), a CD-ROM (Compact Disc Read Only Memory), a CD-R (Recordable)/RW (ReWritable) or the like may be used. The magneto-optical recording medium includes an MO (Magneto-Optical disk) etc.

To market the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the received program.

As described above, according to the present invention, image quality is determined by the image transmitting-side wireless communication device in accordance with the wireless communication state, and image of the determined quality is transmitted. Accordingly, even in the case where the wireless communication state deteriorates, it is possible to transmit image data of smoothly reproducible quality.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A wireless communication device for performing wireless communication with a master station, comprising:
an image encoding unit for encoding image acquired by a camera to obtain image data of instructed quality;
wireless communication means for transmitting, by wireless, the image encoded by said image encoding unit to the master station;
wireless communication state judging means for judging a state of the wireless communication with the master station;
image quality decision means for determining quality of image to be encoded by said image encoding unit, in accordance with the wireless communication state; and
image quality instruction means for instructing said image encoding unit to encode the image with the quality determined by said image quality decision means.

2. The wireless communication device according to claim 1, further comprising processing load measurement means for measuring processing load imposed on said wireless communication means,
wherein said image quality decision means determines quality of image to be encoded by said image encoding unit, in accordance with the processing load on said wireless communication means and the wireless communication state.

3. The wireless communication device according to claim 2, wherein said image quality decision means determines an image quality with higher data compression ratio, out of an image quality matching the processing load on said wireless communication means and an image quality matching the wireless communication state, as the quality of image to be encoded by said image encoding unit.

4. The wireless communication device according to claim 1, wherein said wireless communication state judging means judges the wireless communication state on the basis of a receive level of a predetermined signal transmitted from the master station.

5. The wireless communication device according to claim 4, wherein said predetermined signal is a beacon signal.

6. The wireless communication device according to claim 1, wherein said image quality decision means predicts a future communication state on the basis of the wireless communication state and determines the image quality in accordance with the predicted communication state.

7. The wireless communication device according to claim 1, wherein said wireless communication state judging means detects error of a predetermined signal transmitted from the master station, and judges the wireless communication state on the basis of occurrence of the error.

8. A wireless communication device for performing wireless communication with a master station, comprising:
an image encoding unit for encoding image acquired by a camera to obtain image data of instructed quality;
wireless communication means for transmitting, by wireless, the image encoded by said image encoding unit to the master station;
processing load measurement means for measuring processing load imposed on said wireless communication means;
image quality decision means for determining quality of image to be encoded by said image encoding unit, in accordance with the processing load measured by said processing load measurement means; and
image quality instruction means for instructing said image encoding unit to encode the image with the quality determined by said image quality decision means.

9. A wireless communication method for performing wireless communication with a master station, comprising the steps of:
judging, by wireless communication state judging means, a state of the wireless communication with the master station;
determining, by image quality decision means, quality of image to be encoded by an image encoding unit, in accordance with the wireless communication state;
instructing, by image quality instruction means, encoding of image with the quality determined by the image quality decision means;
encoding, by the image encoding unit, image acquired by a camera to obtain image data of the quality instructed by the image quality instruction means; and
transmitting, by wireless communication means, the image encoded by the image encoding unit to the master station by wireless.

10. A wireless communication program for performing wireless communication with a master station, wherein said wireless communication program causes a computer to function as:
wireless communication means for transmitting image encoded by an image encoding unit which encodes image acquired by a camera to obtain image data of instructed quality, to the master station by wireless;
wireless communication state judging means for judging a state of the wireless communication with the master station;
image quality decision means for determining quality of image to be encoded by the image encoding unit, in accordance with the wireless communication state; and
image quality instruction means for instructing the image encoding unit to encode the image with the quality determined by the image quality decision means.

11. A computer-readable recording medium recording a wireless communication program for performing wireless communication with a master station, wherein the wireless communication program causes a computer to function as:
wireless communication means for transmitting image encoded by an image encoding unit which encodes image acquired by a camera to obtain image data of instructed quality, to the master station by wireless;
wireless communication state judging means for judging a state of the wireless communication with the master station;
image quality decision means for determining quality of image to be encoded by the image encoding unit, in accordance with the wireless communication state; and
image quality instruction means for instructing the image encoding unit to encode the image with the quality determined by the image quality decision means.
